(19) United States
(12) Patent Application Publication
(10) Pub. No.: US 2013/0263441 A1
(43) Pub. Date: Oct. 10, 2013

(54) PLUG AND PLAY BATTERY SYSTEM

(71) Applicant: Design_Net Engineering, LLC, (US)

(72) Inventors: Wayne Boncyk, Evergreen, CO (US); Gerald Murphy, Conifer, CO (US)

(73) Assignee: Design_Net Engineering, LLC, Golden, CO (US)

(21) Appl. No.: 13/857,084

(22) Filed: Apr. 4, 2013

Related U.S. Application Data
(63) Continuation-in-part of application No. 12/710,598, filed on Feb. 23, 2010, now abandoned.
(60) Provisional application No. 61/208,264, filed on Feb. 23, 2009.

(51) Int. Cl. H02J 7/00

(52) U.S. Cl. CPC H02J 7/0068
USPC 29/623.1; 320/101

(57) ABSTRACT

An energy storage module (ESM) for spacecraft has at least one battery. The ESM has a first interface to at least one string of solar cells configured for charging of the battery, a second interface to a spacecraft for outputting power from the battery and a third interface for communicating to other spacecraft modules. The ESM has a charge controller coupled with the battery and the first, second and third interface. The charge controller has a microprocessor with firmware to autoconfigure a system configuration of the battery and, in an embodiment, connections of strings of solar cells to the charge controller, and to present determined configuration and state of charge to other components of the spacecraft. In embodiments, the microprocessor has firmware for contacting another parallel-connected ESM and to present total power available in both ESMs to other modules of the satellite, and charging of the batteries can be coordinated.

### CROSS-REFERENCE TO RELATED APPLICATIONS

This application is a continuation in part of, and claims priority to, U.S. patent application Ser. No. 12/710,598 filed Feb. 23, 2010, which is in turn a nonprovisional of, and claims the benefit of the filing date of, U.S. Provisional Patent Application No. 61/208,264, filed Feb. 23, 2009, entitled “Plug and Play Battery”. The present application also relates to U.S. patent application Ser. No. 12/848,060, which describes plug-and-play processor boards, and a method for configuring those boards using mission design tools. The entire contents of these applications are incorporated herein by reference.

### GOVERNMENT INTEREST

The U.S. Government has rights in this invention pursuant to a grant by the Department of Defense Contract No. FA9453-08-C-0074 awarded by the U.S. Air Force.

### BACKGROUND OF THE INVENTION

Most satellites operating today require electrical power and are solar powered. These satellites have a power system with one or more panels, each having one or more series strings of solar cells that convert sunlight into electrical power, and provide that power to a controller. In other satellites, solar cells are directly attached to a body of the satellite. Since satellites may have peak power demand greater than that produced by the cells, or need power during launch and deployment or while eclipsed by the earth, at least one battery is provided, the controller being arranged to charge the battery when sufficient power is available and the battery is not already fully charged. Typically, the battery is coupled to power a power bus that provides power to other portions of the satellite, in most satellites including at least one telemetry radio transmitter and command receiver.

Most satellites are developed either as a single, special purpose, satellite of unique design, or as small-batch production run of a custom-designed satellite. In either case, the satellite's power system usually custom-designed for that specific satellite design; requiring considerable design-engineering time, effectively prohibiting the rapid design and assembly of new satellite designs, and preventing any benefit of volume production.

Whether designed as a one-of, special-purpose satellite, or in as small batch, it is critical that the design be prototyped and subjected to thorough design-verification testing before launch, since launch costs are high, and after-launch repairs are extremely expensive if not impossible—launch of defectively-designed satellites typically requires satellite replacement at high cost. Typically, such design-verification testing involves verifying correct function of prototype assemblies over a lengthy period of time, at temperature and voltage extremes, to verify the design and certify component lives; all of which is expensive. Once the design is verified, further testing of each production satellite is required. The effect of the design verification testing is to add expense and delay to each satellite.

In order to permit rapid, low cost, design and assembly of new satellite designs, the Space Plug and Play Avionics standard (SPA) has been developed with Air Force funding. The intent is to design, and verify the design of, SPA compatible modules of various types, including sensor-interface, navigation and orientation control, communications (including telemetry transmission and command reception), and processor modules. Once designed, the intent is to construct and stockpile the modules of various types. The intent is that some new satellite designs may be designed, at least in part, by assembling multiple SPA-compatible modules into a satellite structure and programming appropriate firmware into memory of the modules, without requiring new design of major electronic components. The SPA-compatible modules are interconnected, and the modules are expected to interact with each other to inform each other of their identity, so that the modules may associate with each other and configure themselves to operate as a power and electronics package of the satellite into which they have been assembled.

SPA enables relatively fast configuration, integration, test, launch and deployment of space-based systems that are designed to support tactical operational needs of the war fighter in the field. One key requirement of the Operationally Responsive Space (ORS) Office at Kirtland Air Force Base with respect to spacecraft is to rapidly assemble and test spacecraft platforms from standard and depot-based components, potentially significantly reducing time for integration and test of traditional spacecraft from months to days.

A lengthy process in the current art for developing spacecraft energy storage modules (ESMs) typically includes carefully selecting an energy storage device by specifying and sizing battery capacity and technology, such as lithium ion (Li-ion), nickel-cadmium (Ni—Cd) or other chemistry, to meet requirements of a particular spacecraft. The process may also include carefully designing a mission-unique charge control scheme that involves customized charge control hardware and firmware associated with the hardware for the selected energy storage device. Such a design process typically requires considerable labor over many months, and many months of testing.

After the design process, specific ESMs are built to meet the specifications for the particular spacecraft, which often adds more months to the process of developing an energy storage module. The specific requirements for each ESM may include cell voltage, battery voltage, charge management, total energy storage, and peak current capabilities, as well as the solar cells available on the satellite. Traditional ESMs are customized to meet the requirements of each particular mission. Currently, very few off-the-shelf power subsystem configurations are available for last-minute fitting to spacecraft.

One issue with traditional spacecraft batteries for ESMs is their limited shelf life, and requirements for careful maintenance and charge management from the time of assembly until launch. Nearly all current spacecraft batteries are inherently unable to satisfy ORS requirements, since they cannot be stationed at a depot in a flight-ready state for an extended period.

Furthermore, resources are needed to monitor battery charge status and cycles of charge and discharge to maintain battery performance between battery delivery and an actual flight. Hence, the current process requires a long waiting period for battery procurement and extensive resources required for maintenance of rechargeable cells. The current process also requires complicated procedures for integration of a battery into a Power Management And Distribution (PMAD) system design such that it takes a long time to assemble a power subsystem for the spacecraft.

### BRIEF SUMMARY

Embodiments of the invention pertain to techniques that allow Energy Storage Modules (ESM) to be built and stored, requiring only minimal work to make them ready for flight. More specifically, the ESM includes a battery, an SPA standard interface to spacecraft, and a controller having programmable firmware.

In an embodiment, an energy storage device (ESM) for spacecraft has at least one battery. The ESM has a first interface to at least one string of solar cells configured for charging of the battery, a second interface to a spacecraft for outputting power from the battery and a third interface for communicating to other spacecraft modules. The ESM has a charge controller coupled with the battery and the first, second and third interface. The charge controller has a microprocessor with firmware to autoconfigure a system configuration of the battery and, in an embodiment, connections of strings of solar cells to the charge controller, and to present a determined configuration and state of charge to other components of the spacecraft. In embodiments, the microprocessor has firmware for contacting another parallel-connected ESM and to present total power available in both ESMs to other modules of the satellite, and charging of the batteries can be coordinated.

A method of assembling a satellite includes designing an ESM module, such that the ESM module is autoconfigurable to number and type of battery cells, and to number and current input of solar cell chain inputs, these modules then have battery cells installed into them. The ESMs are stored, and when a particular satellite design is prepared, a number of ESMs and a solar array configuration is determined appropriate to meet the needs of the satellite; one or more ESMs is then assembled into a frame of the satellite and cell strings of the determined solar array to inputs of the ESMs, ground power are connected; a microprocessor of each ESM module determines the configuration of that ESM and communicates through an on-satellite network total energy available from the ESM to other units of the satellite, including any telemetry communications modules that may be present.

In another embodiment of the system, an energy storage device for use in a satellite has an energy storage component including a plurality of cells; a first interface to a power source configured for charging of the energy storage component; a second interface to a spacecraft for outputting power from the energy storage component; a third interface for communicating to spacecraft; and a charge controller operatively coupled with the energy storage component and the first, second and third interface. In this embodiment, the charge controller comprises a microprocessor incorporating a firmware to accommodate a system configuration of the energy storage component; wherein the microprocessor has firmware to automatically determine a configuration selected from the group consisting of battery cell configuration and capacity, and solar cell string connections to the first interface; and to report this configuration over the third interface.

### BRIEF DESCRIPTION OF THE DRAWINGS

FIG. 1 is a diagram illustrating a spacecraft with electrical power source and interfaces according to embodiments of the present invention.

FIG. 2 illustrates an exemplary energy storage system according to embodiments of the present invention.

FIG. 2A illustrates an exemplary energy storage system according to alternative embodiments.

FIG. 3 illustrates another exemplary diagram of an energy storage system to provide power to a spacecraft according to embodiments of the present invention.

FIG. 4 is a flow chart illustrating one exemplary method for integration of an energy storage device according to embodiments of the present invention.

### DETAILED DESCRIPTION

Energy storage modules (ESMs) or Plug and Play (PnP) battery systems have been developed to extend shelf life such that the PnP battery systems are depot storable, and adaptable to a wide variety of satellite configurations. These PnP battery systems are configurable to meet the SPA standard to satisfy all ORS requirements in single or multiple ESM configurations. The SPA Standard has been generated by the Department of the Air Force, Air Force Research Lab and managed by ORS. The SPA standard currently has one final published version. A key to developing PnP battery systems fully capable of supporting all envisioned ORS needs is to overcome certain limitations in the traditional spacecraft batteries, charge controllers, autoconfiguration, and load control.

In the present art, there is a need for developing energy storage systems and methods that have long shelf life. There also is need for energy storage systems and methods that provide an energy storage system with a short design lead-time that can be stockpiled for later use in a variety of satellite configurations. There further is a need for energy storage systems and methods that provide an energy storage system that needs less pre-launch maintenance. There is also a need for energy storage systems and methods that provide energy storage systems at low cost.

### Zero-Volt Cell

One aspect of the traditional spacecraft batteries is their limited cell life. Most existing cell technologies applicable to spacecraft systems use nickel-cadmium (Ni—Cd), nickel-metal hydride (Ni-MH), lead acid (Pb-acid), or lithium ion (Li-ion). Li-ion cells or other rechargeable cells possess limited shelf life after battery assembly and initial charge. Most new spacecraft utilize Li-ion cells because of their high energy density. However, conventional Li-ion batteries cannot survive a deep discharge to low voltages because battery performance may degrade both with time and whenever the cell voltage drops below approximately 2 volts per cell.

To prolong Li-ion battery life in customary spacecraft implementations, Li-ion cells typically are allowed to discharge to a cutoff voltage of 2.6 volts. Below or at such a cutoff voltage, a circuit for battery management cuts off the battery discharge. Unfortunately, during prolonged storage, a discharge below such a cutoff voltage level may be possible because of phenomena such as leakage currents in associated circuitry, calendar fade and self-discharge.

A Zero-Volt cell has extended shelf life. For example, Quallion has developed Li-Ion Zero-Volt cells. To mitigate the limitations of earlier Li-ion battery designs, Quallion has designed various cells, such as 15 ampere hour (Ah) and 72 Ah space satellite cells that can safely be discharged to zero volts at any time in its lifecycle, and stored for a prolonged period without performance degradation. For example, Zero-Volt cells retain, for example, 95% of capacity over a prolonged period of storage, such as one year, two years, or five years. Such cells with prolonged shelf life may be built into a battery for use in an energy storage module, according to some embodiments of the present invention.

Another way of prolonging Li-ion battery life is to balance multiple cells to eliminate mismatches of charge of series or parallel coupled cells, which improves battery efficiency and overall pack capacity.

Conventional rechargeable battery chemistries, such as Ni—Cd, Ni-MH and Pb-acid, operate using a dissolution-precipitation reaction where active material structures are disorganized and rebuilt during charge/discharge cycles. Li-ion chemistry has an insertion and dis-insertion chemistry, in which a host structure remains largely intact during a process of absorbing or releasing a guest material such as Li ions. Therefore, Li-ion chemistry may give long cycle life, a stable performance and is less prone to cell balance issues than the conventional rechargeable chemistries.

However, some factors can drive cells out of balance. One factor is that self-discharge rates of cells vary with temperature, and cells of a battery may operate at different temperatures for a variety of reasons including local self-heating effects. Another factor is that level of depth of discharge varies with temperature, and again temperature may vary across a battery. Additional factors include requirements of charge and discharge rates at different temperatures and a number of cycles at varying depth of discharge and temperatures.

For these reasons, it is important during battery design to ensure that all cells in a battery are exposed to similar environmental conditions. The stability of Quallion's Zero-Volt cell may effectively reduce cell-balancing needs such that cell balance circuitry may not be needed for some ORS tactical missions, which typically require at least one year of shelf life.

### Energy Storage System

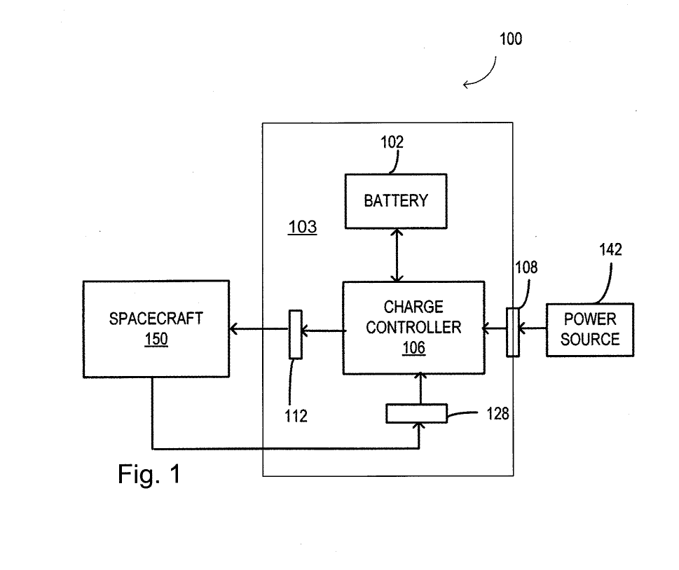

FIG. 1 is a diagram illustrating a system 100 including a spacecraft with power sources and interfaces, including energy storage module 103 (ESM). In system 100, a charge controller 106 receives an activation signal from spacecraft 150 through an activation interface 128 to provide electrical power to spacecraft 150. The activation signal may be triggered when a rocket separates from spacecraft 150 and then signals the system 100 through activation interface 128 to charge controller 106 of ESM 103. Spacecraft 150 then receives electrical power from battery 102 under control of charge controller 106 through a power-out interface 112. An external power source 142 may provide power for charging battery 102 through power-in interface 108 if battery 102 does not have sufficient charge. If battery 102 has sufficient charge, charge controller 106 allows power output from battery 102 to spacecraft 150. If battery 102 does not have sufficient charge, controller 106 allows external power source to charge battery 102 to a sufficient level, and then allows power output from fully charged battery 102 to power spacecraft 150 through power-out interface 112. Power-out interface 112 is often referred to spacecraft main bus power interface.

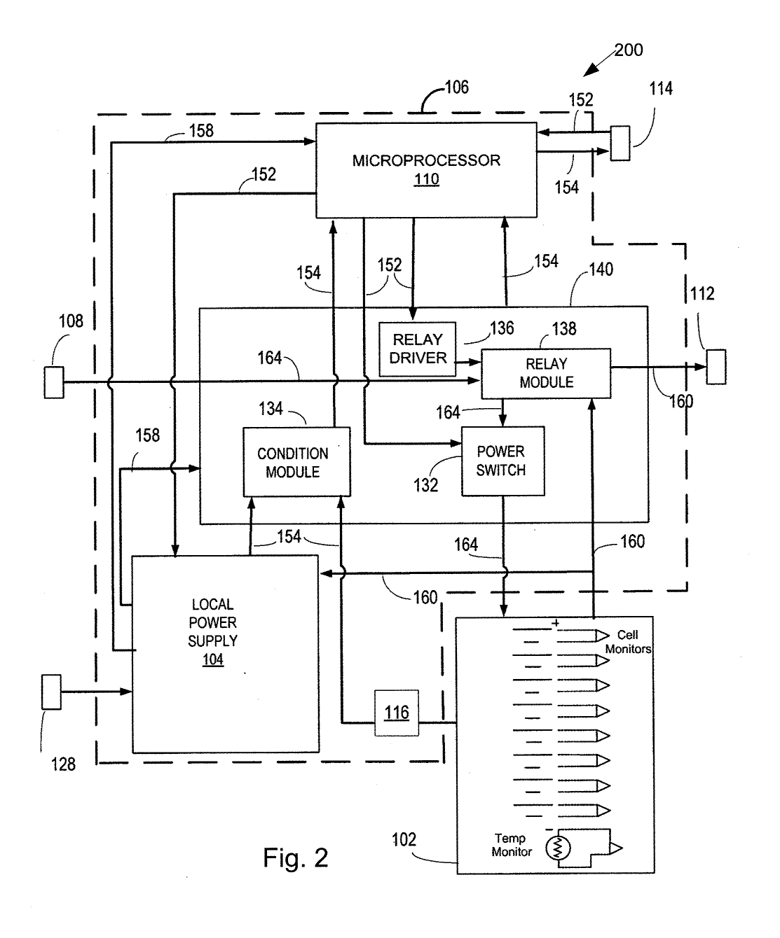

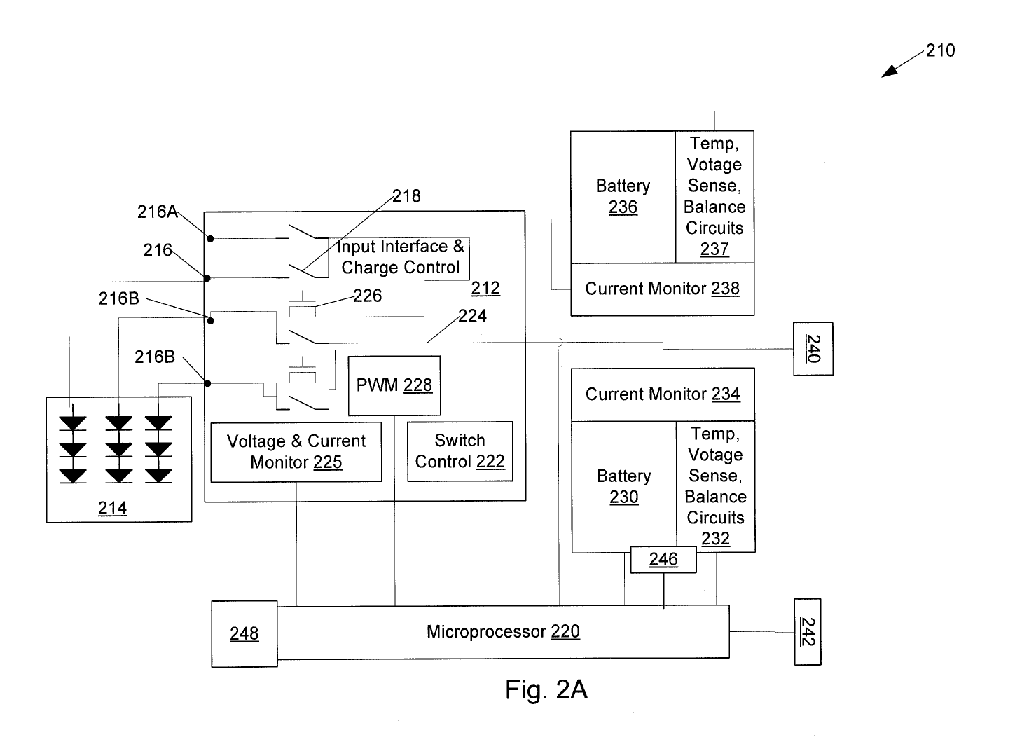

FIG. 2 is a detailed diagram of an exemplary energy storage system 103, 200. System 200 includes a battery 102 and a charge controller 106. System 200 also includes a power-in interface 108 to an external power source 142 for inputting external power to charge battery 102. System 200 further includes a power-out interface 112 for outputting power to spacecraft 150 and a network interface 114 for communicating with spacecraft 150. System 200 also includes an activation interface 128 responsive to external signals to activate charging to battery 102 from external power source 142.

Charge controller 106 includes a microprocessor 110 with interface electronics, a power bus management module 140, and a local power supply 104. Power bus management module 140 includes a conditioning module 134 that collects status information of battery 102 and local power supply 104 and provides the status information to microprocessor 110, a relay module 138 that controls power output from ESM 103 to spacecraft 150, and a power switch module 132 that controls charging of battery 102 from external power source 142. Power bus management module 140 also includes a relay driver 136 that transmits power to relay module 138.

Charge controller 106 may control charging of battery 102 from solar or other power from external power source 142. The solar or other power input through power-in interface 108 may be provided through relay module 138 and power switch module 132 to charge battery 102. External power source 142 may be a photovoltaic solar array in most spacecraft applications. Other power sources may be provided as well for charging battery 102.

According to embodiments of the present invention, provisions are made for self-startup and fault recovery in a Phoenix Mode, and initial activation by using local power supply 104. Local power supply 104 is a set of voltage regulators that receives power from battery 102, converts voltages, and provides power to all electronics including microprocessor 110, relay drive 136, relay module 138, conditioning module 134 and power switch module 132 in system 200.

Local power supply 104 is coupled to microprocessor 110 through control bus 152 and local power bus 158 to provide power to microprocessor 110. Power supply 104 also is adapted to receive command from microprocessor 110. Local power supply 104 is also coupled to battery 102 through battery power bus 160 to draw power from battery 102. Local power supply 104 is further coupled to power bus management module 140 for providing power to all the electronics in power bus management module 140. When local power supply 104 receives an activation signal from activation interface 128, local power supply 104 draws power from battery 102 through battery power bus 160. Local power supply 104 then turns on power to microprocessor 110 through local power bus 158. Microprocessor 110 also sends a command to local power supply 104 to turn on power for all electronics in power bus management module 140.

Battery 102 may output power to spacecraft 150 through battery power bus 160 to relay module 138 and then power-out interface 112. Battery 102 may be, among others, a Li-ion battery including Zero-Volt cells or any other battery that has a prolonged shelf life time and minimal performance degradation over a long period. The shelf life may be at least one year, or two years, three years, preferably five years. Various cell configurations in parallel or series may be used in building battery 102, and the cells may have different chemistry than Li-ion chemistry.

According to embodiments of the present invention, status of battery 102 may be monitored by microprocessor 110 in charge controller 106. For example, battery 102 is coupled to a status monitor 116 in charge controller 106. Status monitor 116 can measure voltage of each of individual cells in battery 102. The individual cells may be connected in series or parallel in battery 102. Status monitor 116 reports a level of charge of battery 102 to microprocessor 110 through conditioning module 134. When battery 102 has enough charge, charge controller 106 turns on main bus power to spacecraft 150 through power-out interface 112 to support normal spacecraft operation.

According to embodiments of the present invention, signal conditioning module 134 takes voltage, current and temperature sensor data from status monitor 116 coupled to battery 102 and other components (not shown) in charge controller 106, and scales the sensor data to standard engineering units (volts, amps, degrees C.). Scaled data are then directed to microprocessor 110 with interface electronics to allow communication with other SPA systems on spacecraft. Battery 102 may output power through power-out interface 112. Energy storage system 103 reports on its capacity and level of charge via SPA standard, through a battery Extensible Transducer Electronics Data Sheet defined in advance. Conditioning module 134 is coupled to microprocessor 110, status monitor 116 and local power supply 104 through status bus 154.

According to embodiments of the present invention, power switch module 132 provides a switching function to battery 102. Power switch module 132 is coupled to microprocessor 110 through control bus 152. Power switch module 132 is also coupled to relay module 138 and battery 102 through solar array power bus 164. Power switch module 132 has a pulse width modulator. Power switch module 132 may be operated with a duty cycle ranging from 0% to 100%. Power switch module 132 controls solar or other power for charging battery 102 based upon the report to microprocessor 110 from status monitor 116 through conditioning module 134. Battery 102 includes a number of cells as shown in FIG. 2. If voltages of the cells are lower than a threshold, microprocessor 110 sends a command to power switch module 132 such that power switch module 132 can be turned on to allow charging of battery 102, with the solar or other power input through power-in interface 108. If the voltages of the cells are above the threshold, power switch module 132 can be turned off so that battery 102 does not receive further charge. Microprocessor 110 controls power switch module 132 based upon the report from status monitor 116.

According to embodiments of the present invention, relay module 138 allows power from power-in interface 108 through power switching module 132 to battery 102 to allow battery charging if status monitor 116 indicates that battery 102 is not adequately charged. Relay module 138 also may allow power output from battery 102 to spacecraft 150 through power-out interface 112 if battery 102 is adequately charged. Relay module 138 is coupled to power-in interface 108 or solar array power interface 108, the power-out interface 112 or main bus power interface 112. Relay module 138 is also coupled to battery 102 through battery power bus 160, relay driver 136 through control bus 152, and power switch module 132 through solar array power bus 164. If a report to microprocessor 110 from status monitor 116 through conditioning module 134 indicates that voltages of the cells are high enough or above a threshold, microprocessor 110 sends a command to relay module 138 through relay driver 136, allowing battery 102 to output power through power-out interface 112. If the report to microprocessor 110 from status monitor 116 via conditioning module 134 indicates that the voltages of the cells are below the threshold, microprocessor 110 sends a command to power switch module 132 to allow charging of battery 102 by inputting the external power through power-in interface 108 and a command to relay module 138 to shut down power output to spacecraft 150 through power-out interface 112.

According to embodiments of the present invention, in the Phoenix Mode, when an anomaly on spacecraft 150 results discharging of battery 102 below an energy level required to maintain normal spacecraft operation, relay module 138 switches off power output to power-out interface 112 through power switch module 132. Meanwhile, local power supply 104 maintains operation of microprocessor 110, which configures relay module 136 to transmit external power through power-in interface 108 to charge battery 102 to recover adequate level of charge. Relay driver 136 transmits power to control the relays in relay module 138.

According to embodiments of the present invention, microprocessor 110 is coupled to conditioning module 134 through status bus 154, power bus management module 140 through status bus 154 and network interface 114. Microprocessor 110 can collect the status information of all components including battery 102, local power supply 104 and power bus management module 140 through status bus 154 and report to spacecraft 150 through network interface 114. Microprocessor 110 is also coupled to control charge controller 106 components including relay driver 136, power switch module 132 and local power supply 104 through control bus 152, as well as network interface 114. Microprocessor 110 can receive commands from the spacecraft through network interface and send command to those components in charge controller 106.

Microprocessor 110 incorporates a programmable firmware. Such a firmware allows flexibility to provide batteries with any desired configurations, such as cell voltage, battery voltage, charge management, total energy storage, and peak current capabilities.

In a typical operation, system 200 receives a command signal from the rest of spacecraft 150 through activation interface 128. The command signal indicates that spacecraft 150 has separated from a launch vehicle. The command signal turns on local power supply 104, which gets input power directly from battery 102. Local power supply 104 activates all electronics in power bus management electronics 140, then activates microprocessor 110 with interface electronics by turning on its local power. Microprocessor 110 examines the level of charging of battery 102 through status monitor 116. Signals from status monitor 116 are calibrated in signal conditioning module 134. If the level of charge is sufficient, power bus management electronics 140 turns on main bus power to spacecraft 150 through relay module 138 and power-out interface 112. If the level of charging is not sufficient, system 200 enters a “Phoenix Mode”, in which relay module 132 supplies power to battery 102 from external power source 142, while the main bus power to spacecraft 150 is off. Once battery 102 is adequately charged, microprocessor 110 changes the state of relay module 132 to turn on the main bus power to spacecraft 150 through power-out interface 112. Microprocessor 110 communicates to the rest of spacecraft 150 through network interface 114. Network interface 114 may allow communication with a Power Management and Distribution system that includes power management firmware running on a separate spacecraft power-management processor. Spacecraft 150 may send command to microprocessor 110 through network interface 114 to reconfigure the operation of system 200 for various needs. Microprocessor 110 incorporates firmware responsible for charging and maintaining battery 102. The firmware during normal spacecraft operation seeks to maintain an adequate battery charge by regulating the amount of power from external power source 142 into battery 102 through power switching module 132.

In an embodiment, charge controller 106 has multiple inputs. Each input is adapted such that it may be coupled to a separate series string of solar cells.

In an alternative embodiment, ESM 210 has a power-in interface 212, or first interface, that serves to interface ESM 210 through multiple inputs 216 to multiple strings 214 of parallel, or series-parallel, connected solar cells on one or more panels. While each input 216 may be connected to strings 214, it is anticipated that in some embodiments one or more of inputs 216, such as input 216A, may be left unconnected in some satellites. In an embodiment, inputs 216 are of two types, 216, 216B. A first type 216, 216A has an electronically controlled switch 218 that is opened or closed under control of microprocessor 220 acting through a switch controller 222, each switch 218 acting to couple an associated input of inputs 216 to an ESM power bus 224. One or more of the inputs is of a second type 216B where either the switch 218 is capable of high-speed operation, or the switch is coupled in parallel with a high-speed switching device such as a field-effect transistor 226. Field-effect transistor 226 operates is driven by pulse-width modulators 228 under control of microprocessor 220 and, if any parallel switch 218 associated with that input is open, can effectively modulate power from inputs 216B that reaches ESM power bus 224. Voltage and current monitor 225 is provided, with ability to monitor charging current received through each photovoltaic solar cell string 214, and with the ability to monitor voltage at the input from each solar cell string 214. ESM power bus 224 is coupled to a battery 230 through current-monitoring apparatus 234. Battery 230 is equipped with voltage and temperature monitors, and in some embodiments balancing circuitry, 232 that monitor both individual cell voltages and overall battery voltage, an provides for some current to bypass one or more cells to allow for a periodic balancing charge. Battery 230 is a nickel metal hydride or lithium-ion battery, and in some embodiments is a lithium iron-phosphate battery. In some embodiments, Battery 230 uses the zero-volt cell previously discussed. In some embodiments, ESM power bus 224 is also coupled to a second battery 236 through current-monitoring apparatus 238. Battery 236 is equipped with voltage and temperature monitors and, in some embodiments, balancing circuitry 237, and has the same chemistry as battery 230. ESM power bus 224 is brought out of the ESM through a suitable connector 240 to a main power bus of the spacecraft. When power is first applied to the ESM in an assembled satellite, Microprocessor 220 executes machine readable instructions of firmware in a memory 240 associated with the microprocessor to determine how many, batteries 230, 236 are present in the system by, in an embodiment, which batteries show non-zero current at current monitors 238, 234, and which batteries indicate at least one non-zero cell voltage at voltage monitors 237, 232. In some embodiments, at least one battery is assembled together with a small serial-interface programmable read-only memory, or other nonvolatile memory 246 (NV-Memory) having battery type information that is readable by the microprocessor and is programmed with a battery-chemistry identification and capacity rating, this is also read by the microprocessor when power is first applied to the ESM. In the event no NV-memory is found, a particular battery chemistry is assumed, and capacity is determined by tracking battery voltage with state of charge (determined from integrated current at the battery) during an initial period of operation. The microprocessor then configures itself and the ESM for the number, capacity, and type of installed batteries, selecting charge-control parameters from a table of parameters for each battery chemistry and located in a memory 248 of the microprocessor.

Once the microprocessor has configured itself and the ESM for the number, size, and type of the installed batteries, presents this information through an SPA-compatible network interface 242 as automatically-generated configuration information to any other electronic modules of the satellite, including making this information available as telemetry information to any communications electronics modules, and as power-available information to any satellite main processor.

When power becomes available through the solar power-in interface 212, such as when the satellite has been launched and solar panels deployed, and sunlight is available at solar cell strings 214, the microprocessor executes machine readable instruction of the firmware to monitor voltages received at each input 216, 216B, 216A, to determine which inputs are connected to cell strings, and configures itself to operate the ESM appropriately. In an embodiment, the microprocessor sequentially enables all switches 216 coupled to cell strings to determine current available from those strings. A total solar cell current available is generated and provided through the SPA-compatible network interface 242 to other SPA-compatible units of the satellite as automatically-generated satellite configuration information.

Since batteries of many chemistries can be destroyed if overcharged, once autoconfiguration is complete and normal operation begins, microprocessor 220 controls voltage on ESM power bus 224 by configuring switches 218 to a pattern that prevents overcharging batteries 230, 236, and modulates power received through one or more field-effect transistors 226 to accept only much power from connected inputs 216, 216B as will avoid overcharge. Processor 220 also uses current monitors 234, 238 to determine a state of charge of batteries 230, 236, and regularly provides updated battery charge-state, power available from cell strings 224, and current drain information over the SPA interface 242 to other SPA-compatible modules of the satellite; in a particular embodiment this information includes a request that satellite systems shed load to conserve charge when charge is insufficient to maintain drain. In a particular embodiment, state of charge is determined by integrating current at charge monitors 234, 238. In particular embodiments, additional power relays and electrically actuated power switches may be provided to provide a phoenix mode, as discussed with reference to FIG. 2.

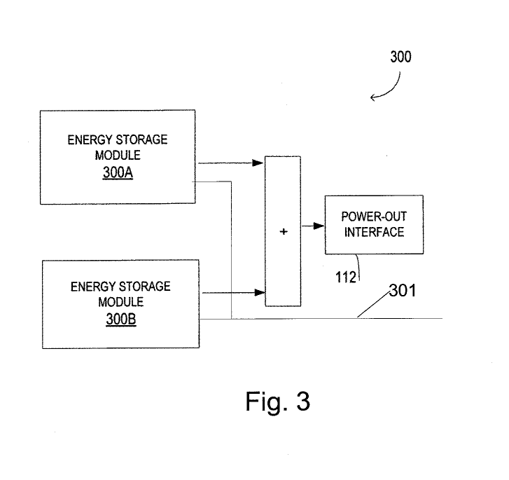

The tight integration of the SPA, battery and power controller elements illustrated in FIG. 2A allows for the immediate autoconfiguration of the battery and power-controller elements such that this configuration can be provided to the remainder of the satellite system. The satellite system is then able to discover and us the self-contained power subsystem that provides subsystem-level operability immediately after it is plugged into the spacecraft. The integrated assembly allows for inclusion of a stable PMAD subsystem in a spacecraft design without the need for the kind of extensive testing, stability analyses, and calibration required if disparate elements were to be brought together, even if those elements were individually SPA compatible. With the integrated assembly pre-packaged as a SPA compliant unit, the user knows that the PMAD “lego block” was stable and robust. Larger spacecraft with a need for more power (more energy storage, etc.) would simply add more ESM “lego blocks” without any need for analyses or testing to demonstrate the compatibility or stability off the new assembly, as discussed below with reference to FIG. 3.

The available output current through power-out interface 112, 240 may be increased by connecting two PnP modules in parallel. FIG. 3 illustrates an exemplary diagram of two energy storage systems for providing power output to an interface to spacecraft 150. System 300 includes a first energy storage system 300A and a second energy storage system 300B. The output currents from energy storage systems 300A and 300B are added and then output to power-out interface 112, 240. Each of the two energy storage systems 300A and 300B may be an energy storage system 200, 210, as illustrated in FIG. 2 or 2A.

In an embodiment of the dual-PnP ESM module of FIG. 3, when microprocessor 220 of each ESM has configured itself by determining a number of batteries available, and has provided configuration information on the SPA network; each microprocessor 220, such as the microprocessor of module 300A, communicates with the microprocessor of other modules, such as the microprocessor of module 300B, over the SPA network 301, and with other modules of the satellite. Since the outputs of both ESMs are coupled together in parallel, the microprocessors of the ESMs 300A, 300B coordinate charge control and, when necessary, charge balancing operations to maintain an appropriate state of charge in all batteries of the satellite. The microprocessors designate a master ESM that then provides total power availability information, including available solar power and state of charge, to other modules of the satellite.

### Integration of PnP Battery System

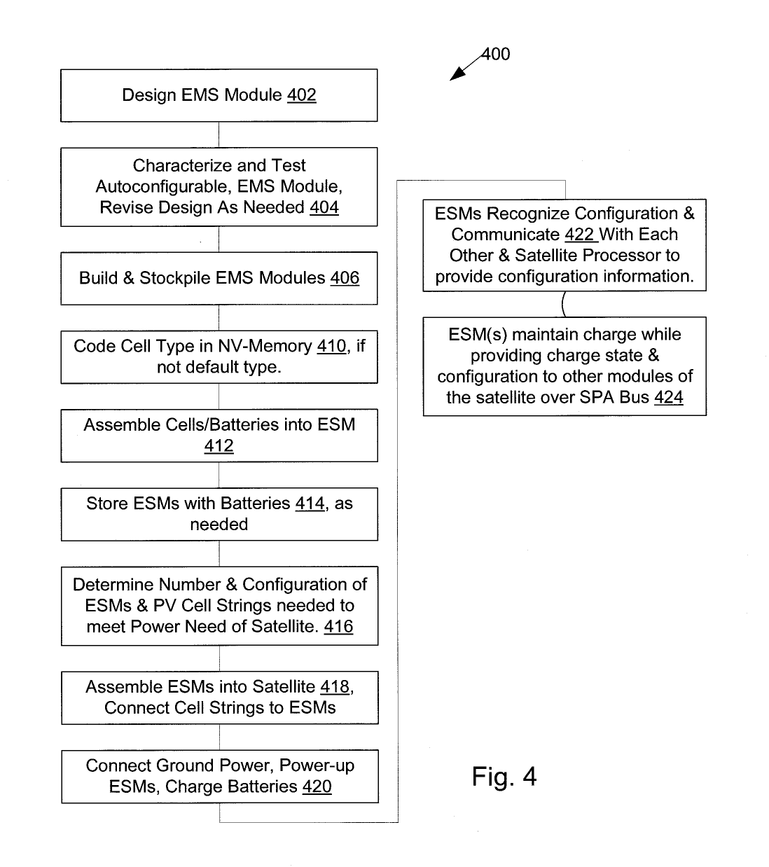

FIG. 4 is a flow chart illustrating one exemplary method 400 of designing, storing, and integrating an energy storage device into a satellite system, and deploying the satellite. Method 400 starts with design of the ESM module, 402 such that the ESM module is autoconfigurable and SPA compliant as herein described. The ESM module is prototyped and tested 404 thoroughly to ensure it is stable and fully meets requirements; once the design is finalized, ESM modules are built and stockpiled 406.

Since battery cells tend to be of shorter storage life than other components of the ESM, when it is anticipated that stockpiled ESMs are to be used within a time less than a shelf-life of cells, if the cell type is other than that assumed by microprocessor 220 of the PnP ESM, a cell type is programmed 410 into a NV-Memory and cells and NV-Memory and cells are assembled 412 into ESMs from the stockpile. These battery-installed ESMs may be further stored 414 for a time determined from a cell storage shelf-life.

When a need for a specific satellite arises, a number of ESM modules to provide an adequate number of PV cell-string inputs and an appropriate number and size of batteries, and a solar array configuration, appropriate to meet the needs of the satellite is determined 416. The determined battery-installed ESM modules are assembled 418 into the satellite frame, cell strings of the determined solar array are connected to inputs of the ESMs, ground power is connected, and all batteries charged 420. The microprocessors of the ESMs then determine the configuration of their own modules, and communicate through the SPA network, or other on-satellite network, to determine a master ESM and to provide 422 total power available and detailed configuration information to other units of the satellite, including any telemetry communications modules that may be present.

Once launch takes place, and solar panels are deployed, the microprocessor of the ESM acts to maintain 424 to maintain charge, or in a multiple ESM configuration cooperates with the microprocessor of all other ESMs in the system, to maintain charge. The ESM(s) thereupon continue to provide charge state & configuration to other modules of the satellite over SPA Bus.

Network interface 114 may be a SPA standard communication interface, according to embodiments of the present invention. The SPA standard communication interface allows immediate plug-in compatibility of the finished PnP battery system into a SPA-based PnP spacecraft. The SPA standard communication interface also allows applications within the data-centric network to query for data with specific characteristics, subscribe to suitable matches, and manage multiple instances of data to facilitate fault tolerance and robustness.

The incorporation of a charge control firmware into charge controller 106 eliminates the need for development of customized firmware to perform charge management. The use of common charge control electronics in charge controller 106 eliminates the need for time consuming hardware design. Thus, a PnP battery system can be constructed from standard components and programmed with the general charge control firmware within days of obtaining the cells. When requested at any time, a PnP battery system can be pulled off the shelf at an avionics depot, either with or without batteries installed. If batteries are not yet installed, they are added. The PnP battery system may be initially charged and installed on a particular spacecraft so that the PnP battery system may be tested and fully integrated into the spacecraft in hours. Such integration would eliminate long time required for battery development and its integration into the spacecraft in traditional technologies.

One of the benefits of the ESM or PnP battery system is that it has a standard off the shelf configuration, rather than a custom build configuration. The PnP battery system meets the needs of different missions by allowing multiple ESM-Battery units to be integrated onto a single spacecraft as specified. Additionally, the ESM design is robust enough to support several different configurations of Zero-Volt cells without changing hardware, but only changing a charge control firmware. Thus, the PnP battery system may be integrated for depot-shelf availability by using electronics design. Use of cells having prolonged shelf life time allows completing PnP battery systems much faster than use of traditional cells. In addition, the PnP battery system may be stockpiled for years in advance of anticipated need.

Another benefit of the ESM is that it has SPA compliance, which enables network-based and data centric spacecraft system management. SPA compliance also provides necessary configuration flexibility to support the “six day” satellite integration that is a core goal of ORS tactical mission capability. The incorporation of standard interfaces and SPA communication protocols (xTEDS) means that the time typically required to design mission-specific interfaces can also be significantly shortened.

An additional benefit of the ESM or PnP battery system is a potential reduction in cost associated with cell balancing, customized program for energy management and customerized hardware for building the energy storage module in traditional energy storage devices.

While the above is a description of specific embodiments of the present device and method, various modifications, variations and alternatives may be employed. Moreover, other battery chemistries could be employed. Examples of possible variations also include changing the sequence of steps in integration of the energy storage system from the sequence shown in FIG. 4.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method of assembling a satellite comprising
designing an ESM module, 402 such that the ESM module is autoconfigurable to number and type of batteries, and to number and current input of solar cell chain inputs;
manufacturing one or more ESMs;
assembling at least one battery into each ESM;
storing the ESM;
determining a number of ESMs and a solar array configuration, appropriate to meet the needs of a particular satellite installing ESMs into a frame of the satellite;
coupling cell strings of the determined solar array to inputs of the ESMs;
determining by a microprocessor of each ESM the configuration of each ESM; and
communicating through an on-satellite network total energy available from the ESM to other units of the satellite.

2. The method of claim 1 further comprising programming a nonvolatile memory with cell type information.

3. The method of claim 1 wherein storing the ESM is performed after assembling the battery into the ESM.

4. The method of claim 1 wherein storing the ESM is performed before assembling the battery into the ESM.

5. The method of claim 1 further comprising autoconfiguring the ESM for a particular set of solar cell strings installed on the satellite and coupled to an input of the ESM.

6. The method of claim 5 further comprising contacting a microprocessor of a second ESM over the on-satellite network, and providing total energy available to other modules of the satellite system

7. The method of claim 6 further comprising communicating with the microprocessor of the second ESM to coordinate charging of the batteries.

8. The method of claim 1 wherein at least one ESM of the satellite has at least two batteries.

9. An energy storage device comprising:
an energy storage component including a plurality of cells, each cell having a minimum shelf life;
a first interface to a power source configured for charging of the energy storage component;
a second interface to a spacecraft for outputting power from the energy storage component;
a third interface for communicating to spacecraft; and
a charge controller operatively coupled with the energy storage component and the first, second and third interface, wherein:
the charge controller comprises a microprocessor incorporating a firmware to accommodate a system configuration of the energy storage component;
wherein the firmware includes instructions to automatically determine a configuration selected from the group consisting of battery cell configuration and capacity, and solar cell string connections to the first interface; and to report this configuration over the third interface.

10. The energy storage device of claim 9, wherein the charge controller comprises a conditioning module operatively coupled to the energy storage component, the internal power supply, and the microprocessor.

11. The energy storage device of claim 10 wherein the energy source is a plurality of strings of solar cells.

12. The energy storage device of claim 9, wherein each of the plurality of cells comprises a Zero-Volt cell having minimum shelf life of at least one year.

13. The energy storage device of claim 9, wherein the plurality of energy storage components are connected in parallel.

14. The energy storage device of claim 9 further comprising a second energy storage component including a plurality of cells, each cell having a minimum shelf life;
a fourth interface to a power source configured for charging of the energy storage component;
a fifth interface to a spacecraft for outputting power from the energy storage component, the fifth interface coupled in parallel with the second interface;
a sixth interface for communicating to spacecraft; and
a second charge controller operatively coupled with the energy storage component and the fourth, fifth, and sixth interface, wherein:
the charge controller comprises a second microprocessor incorporating a firmware to accommodate a system configuration of the energy storage component;
wherein the second microprocessor has firmware to automatically determine a configuration selected from the group consisting of battery cell configuration and capacity, and solar cell string connections to the fourth interface; and to report this configuration over the sixth interface;
and wherein the microprocessor and the second microprocessor have firmware to coordinate charging of the first and second energy storage components.

15. The energy storage device of claim 14, wherein each of the plurality of cells comprises a Zero-Volt cell.

16. The energy storage device of claim 14, wherein the third interface conforms to the Space Plug and Play Avionics network standard.
